(19) United States
(12) Patent Application Publication
(10) Pub. No.: US 2006/0186035 A1
(43) Pub. Date: Aug. 24, 2006

(54) Filter for a cartridge, a cartridge, use of a filter in a cartridge and a system for preparing a liquid solution for a medical procedure

(76) Inventors: Ragnar Tryggvason, Loddekopinge (SE); Jan-Olof Lorentzon, Rockneby (SE)

Correspondence Address: Finnegan Henderson Farabow;Garrett & Dunner, 901 New York Avenue NW, Washington, DC, 20001-4413, US

(21) Appl. No.: 10/552,629

(22) PCT Filed: Apr. 7, 2004
(86) PCT No.: PCT/SE04/00557

§ 371 Date: Oct. 7, 2005

Related U.S. Application Data
(60) Provisional application No. 60/461,659, filed on Apr. 7, 2003.

(30) Foreign Application Priority Data
Apr. 7, 2003 (SE) 0301021-2

(51) Int. Cl. B01D 35/28

(52) U.S. Cl. 210/435; 210/263; 210/455

(57) ABSTRACT

The invention refers to a filter (23, 24) a cartridge (9) containing a particulate material (20), a use of the filter and a system for preparing a liquid solution. The cartridge (9) includes an inner space (10) for housing the particulate material (20), an inlet (21) arranged to permit the introduction of a liquid into the inner space, and an outlet (22) arranged to permit discharge of liquid from the inner space. The filter (23) is arranged at the outlet (22) to permit passage of the liquid in a filter direction (x) through the filter but to prevent passage of the particulate material through the filter. The filter includes at least one slit-shaped opening, which has a first extension and a second extension being substantially perpendicular to the filter direction (x). The second extension is significantly shorter than the first extension.

### BACKGROUND OF THE INVENTION AND PRIOR ART

The present invention refers to a filter for a cartridge containing a particulate material, wherein the filter is intended to permit passage of a liquid through the filter and thus the cartridge, but to prevent passage of the particulate material, wherein the filter permits the liquid to pass through the filter in a filter direction. The present invention also refers to a cartridge arranged to contain a particulate material, wherein the cartridge includes: an inner space for housing the particulate material; an inlet arranged to permit the introduction of a liquid into the inner space; an outlet arranged to permit discharge of liquid from the inner space; and at least a first filter arranged at the outlet and to permit passage of the liquid through the filter, but to prevent passage of the particulate material through the filter, wherein the filter permits the liquid to pass through the filter in a filter direction. Moreover, the present invention refer to a use of a filter in a cartridge containing a particulate material, wherein the cartridge includes: an inner space for housing the particulate material; an inlet arranged to permit the introduction of a liquid into the inner space; an outlet arranged to permit discharge of liquid from the inner space; and at least one filter arranged at the outlet and to permit passage of the liquid through the filter but to prevent passage of the particulate material through the filter, wherein the filter permits the liquid to pass through the filter in a filter direction. The present invention also refers to a system for preparing a liquid solution for a medical procedure.

In a dialysis equipment, it is known to use such a cartridge for the supply of different substances to the dialysis liquid, see EP-B-278 100. The particulate material contained in the cartridge may include various substances to be supplied to the dialysis liquid, such as sodium bicarbonate, sodium chloride and other salts. In use, the dialysis liquid is flowing through the cartridge, wherein the particulate substance is successively dissolved and thus added to the dialysis liquid. Consequently, the general purpose of the filter is to permit the passage of the dialysis liquid together with a dissolved quantity of the substance, but to prevent the passage of any particles of the particulate material. If such particles of the substance are contained in the dialysis liquid, sensible parts of the dialysis equipment, such as pumps, may be damaged.

The filter used today in such a cartridge is made of a fibre material, such as polypropylene, in the form of a woven filter net. Such a filter is flexible, and thus not self-supporting. The filter, therefore, has to be supported by a supporting component, for instance in the form of a support plate. The filter is mounted to the support plate in a position adjacent to the support plate, wherein the filter and support plate form a common unit that is mountable in the cartridge. The manufacture of such a filter unit is relatively complicated and expensive, since the manufacture includes the separate steps of manufacturing the woven filter, manufacturing the support plate and joining the filter and the plate to each other. Moreover, it is difficult to obtain exactly the desired permeability for such a filter. In particular, the permeability frequently is to high, which involves a risk for formation of channels in the particulate material contained in the cartridge.

Another problem which may occur with the cartridges used today is that the particulate material may escape from the cartridge through the inlet and the outlet before the cartridge is actually used, especially via the inlet during the initial priming operation. In order to reduce this risk of escape, a felt pad or any other similar porous member is incorporated in the inlet and the outlet. In particular, during priming from below, via the outlet, the felt pad at the inlet is important. The porous felt pad is normally manufactured in another material than the rest of the cartridge, which is disadvantageous from a recycling point of view.

### SUMMARY OF THE INVENTION

The object of the present invention is to provide an improved filter for a cartridge containing a particulate material. In particular, it is aimed at a filter, which is inexpensive to manufacture and which demonstrates a uniform and reliable permeability.

This object is achieved by the filter initially defined, which is characterised in that the filter includes at least one slit-shaped opening, which has a first extension and second extension being substantially perpendicular to the filter direction and to the first extension, wherein the second extension is significantly shorter than the first extension.

By such a filter, a uniform flow area of the slit-shaped opening or slit-shaped openings is ensured. Any particles of the particulate material having a minimum size larger than the second extension will be efficiently prevented from passing the filter, and thus from causing any damages to components arranged downstream the filter. Such a filter at the inlet of the cartridge also permits the achievement of a desired pressure drop over the filter. With an appropriate pressure drop a channelling in the particulate material may be avoided. It should also be pointed out that such a filter may be manufactured in an inexpensive manner by means of an injection moulding process.

According to an embodiment of the invention, the second extension is also significantly shorter than the length of the slit-shaped opening in the filter direction. This feature permits a certain thickness of the filter ensuring a sufficient strength of the filter. Consequently, the filter is self-supporting and does not need any support plate to be provided adjacent to the filter, which also contributes to reducing the manufacturing costs.

According to a further embodiment of the invention, the second extension is equal to or less than 0.12 mm, preferably equal to or less than 0.10 mm or 0.08 mm. Moreover, the second extension may be equal to or more than 0.02 mm, preferably equal to or more than 0.04 mm. According to an advantageous embodiment, the second extension is approximately 0.06 mm.

According to a further embodiment of the invention, the filter is made of a polymer material, including one of polypropylene and polycarbonate.

According to a further embodiment of the invention, the filter includes a filter element, wherein the slit-shaped opening extends through the filter element. Advantageously, the filter includes a plurality of such slit-shaped openings, which extend through the filter element. Such filter element may be easily moulded in one single piece. The first extension of each slit-shaped opening may extend in a radial direction towards a centre point of the filter element, providing a plurality of slit-shaped openings in a star-like configuration.

According to a further embodiment of the invention, the filter element has a shape of a substantially plane disc. Such a shape is easy to manufacture and is suitable for the filter at the inlet and the outlet of the cartridge.

According to another embodiment of the invention, the filter element has a conical shape. Such a conical shape is also easy to manufacture and is suitable for the filter at the inlet and the outlet of the cartridge. This conical shape is particularly suitable for the filter at the inlet of the cartridge. The filter may then be mounted in an attachable cover of the cartridge, wherein the tip of the conical filter element is pointing away from the inner space of the cartridge. Liquid may then flow through the slit-shaped openings and on the conical outer surface of the filter element. Moreover, the filter may include a peripheral support portion connected to the filter element and adapted to abut an inner wall of the cartridge. The peripheral support portion may then advantageously have a peripheral surface and include a plurality of ridges projecting from the peripheral surface and adapted to abut the inner wall of the cartridge so that a thin gap is formed between the peripheral surface and the inner wall, said gap providing a further passage for the liquid. In such a way it may be ensured that a sufficient amount of liquid is always present in the cartridge.

According to a further embodiment of the invention, the slit-shaped opening has an first end and a second end, wherein the second extension of the slit-shaped opening increases from a minimum value at one of the ends of the slit-shaped opening to a maximum value at the other end of the opening. Such a shape of the slit-shaped opening or openings is advantageous from a manufacturing point of view. If the first end of the openings faces the inner space of the cartridge and thus the particulate material, the particulate material is efficiently prevented from leaving the cartridge. However, even if the second end faces particulate material a proper functioning of the filter is achieved, i.e. particulate material will be efficiently prevented from leaving the cartridge.

According to another embodiment of the invention, the filter includes a filter element formed by a first disc and a second disc, which are arranged in parallel with each other and separated from each other by an interspace that form the split-shaped opening. Advantageously, the interspace is formed by distance members arranged in the interspace between the discs, each of said distance members having a predetermined height corresponding to the second extension. Furthermore, each of said distance members may include a projection extending from one of the first disc and the second disc. In order to provide said liquid passage through the filter, the first disc may be provided with at least one aperture forming an inlet passage to the interspace, and the second disc with at least one aperture forming an outlet passage from the interspace.

According to a further embodiment of the invention, the filter is made through an injection moulding process.

The object is also achieved by the cartridge initially defined, which is characterised in that the filter includes at least one slit-shaped opening, which has a first extension and a second extension being substantially perpendicular to the filter direction and to the first extension, wherein the second extension is significantly shorter than the first extension.

Advantageous embodiments of the cartridge are defined in the dependent claims 24 to 43.

The object is also achieved by the cartridge initially defined, which is characterised in that the second filter includes at least one slit-shaped opening, which has a first extension and a second extension being substantially perpendicular to the filter direction and to the first extension, wherein the second extension is significantly shorter than the first extension.

Advantageous embodiments of the cartridge are defined in the dependent claims 45 to 60.

Furthermore, the object is achieved by the use of such a filter in such a cartridge, wherein the use includes the step of supplying said liquid to the cartridge in such a way that the liquid passes through particulate material and thereby dissolves at least a part of the particulate material to form a liquid solution. The liquid may be a a dialysis liquid. The particulate material may include bicarbonate, and/or sodium chloride: the particulate material may also include a cleaning substance. A cartridge with such a cleaning substance may be used for instance for cleaning of a dialysis machine.

Furthermore, the object is achieved by the system initially defined, which is characterised in that the filter includes at least one slit-shaped opening, which has a first extension substantially perpendicular to the filter direction and a second extension substantially perpendicular to the filter direction and to the first extension, wherein the second extension is significantly shorter than the first extension. Advantageous embodiments are defined in claims 66 to 69

### BRIEF DESCRIPTION OF THE DRAWINGS

The present invention is now to be described more closely by the following description of various embodiments and with reference to the drawings attached.

FIG. 1 discloses schematically a system for preparing a liquid solution for a medical procedure.

FIG. 2 discloses schematically a cartridge according to the present invention.

FIG. 3 discloses schematically a plan view of a first embodiment of a filter to be arranged in the cartridge of FIG. 2.

FIG. 4 discloses schematically a sectional view of the filter along the line IV-IV in FIG. 3.

FIG. 5 discloses schematically a sectional view of the filter along the line V-V in FIG. 3.

FIG. 6 discloses schematically a plan view of a second embodiment of a filter to be arranged in the cartridge of FIG. 2.

FIG. 7 discloses schematically a sectional view of the filter along the line VII-VII in FIG. 6.

FIG. 8 discloses schematically a cartridge having a filter according to a third embodiment of the present invention.

FIG. 9 discloses schematically a perspective view of the filter disclosed in FIG. 8.

FIG. 10 discloses schematically another perspective view of the filter disclosed in FIG. 8.

### DETAILED DESCRIPTION OF VARIOUS EMBODIMENTS OF THE INVENTION

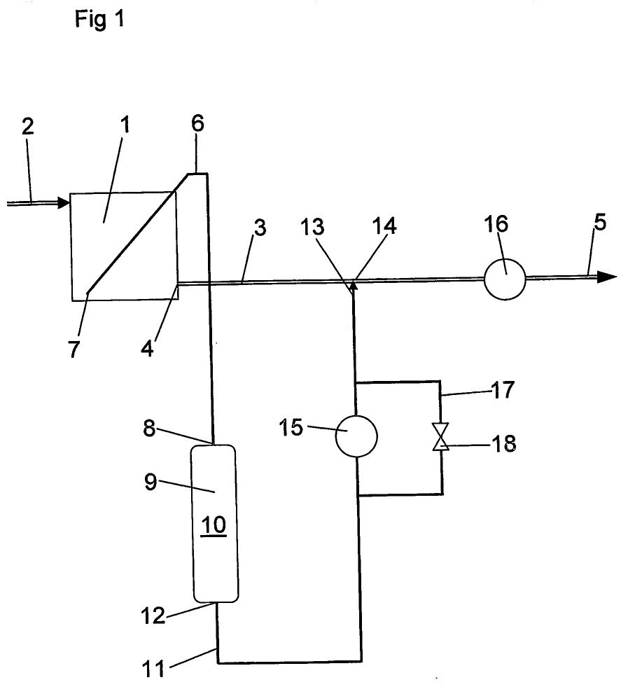

FIG. 1 discloses schematically a system for preparing a liquid solution for a medical procedure. In particular, the system is designed for preparing a dialysis liquid solution for the performance of a hemodialysis treatment. The system may also be used for hemodiafiltration and hemofiltration. The system disclosed in FIG. 1 may thus form a part of a dialysis equipment.

The system includes a source 1 containing a liquid, and in particular a dialysis liquid. The source 1 may be supplied with the liquid via an inlet conduit 2. A first liquid conduit 3 has a first end 4 communicating with the source 1 to withdraw the dialysis liquid into the first liquid conduit 3. The first liquid conduit 3 also has a second end 5 for delivering a dialysis liquid solution to a receiver (not disclosed) such as a dialysis equipment. A second liquid conduit 6 has a first end 7 communicating with the source 1 and a second end 8 communicating with the inlet of a cartridge 9 for the introduction of the liquid from the source 1 into an inner space 10 of the cartridge 9 to produce a concentrate liquid solution. A third liquid conduit 11 has a first end 12 communicating with the outlet of the cartridge 9 and a second end 14 communicating with the first liquid conduit 3 at a mixing point 13 intermediate said first end 4 and said second end 5.

The third liquid conduit 11 is thus arranged to withdraw said concentrate liquid solution from the cartridge 9 into the first liquid conduit 3 to be mixed with the liquid conducted through the first liquid conduit 3 from the source 1 in order to produce a liquid solution for delivery to said receiver. The concentrate liquid solution is transported through the third liquid conduit 11 by means of a pump 15. The liquid is transported from the source 1 to said receiver through the first liquid conduit 3 by means of a pump 16. A control loop 17 including a valve 18 may be arranged to control the quantity of concentrate liquid solution to be delivered to the liquid of the first liquid conduit 3.

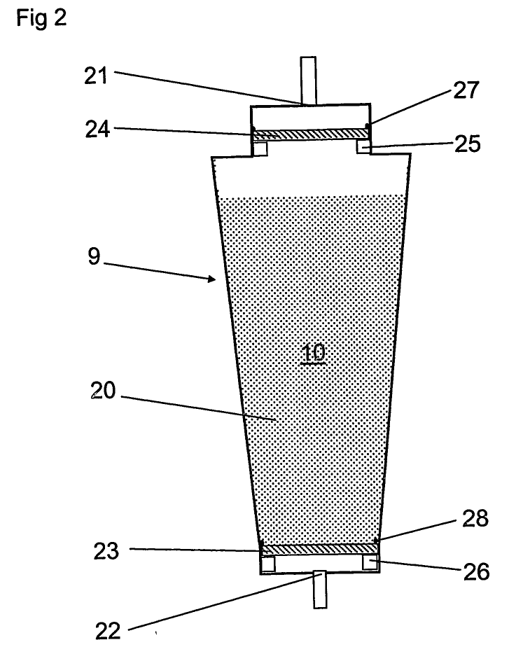

The cartridge 9 is explained below with reference to FIG. 2. In the embodiment disclosed, it is referred to the production of a dialysis liquid solution to which sodium bicarbonate has been added. It is to be noted that also other substances than sodium bicarbonate can be added in a similar manner to the dialysis liquid, for instance sodium chloride and other salts. It is also to be noted, that the system, the cartridge and the components included therein can be used also for producing other liquid solutions than a dialysis liquid.

The cartridge 9 is arranged to contain a particulate material 20 in the inner space 10. In the embodiment disclosed the particulate material 20 is a sodium bicarbonate powder. The cartridge 9 has an inlet 21 which is arranged to permit the introduction of a liquid into the inner space 10. In the embodiment disclosed the inlet 21 is connected to and communicates with the second liquid conduit 6. The cartridge 9 also has an outlet 22 arranged to permit the discharge of liquid from the inner space 10. In the embodiment disclosed, the outlet 22 is connected to and communicates with the third liquid conduit 11 for discharging the concentrate liquid solution.

A first filter 23 is arranged at the outlet 22 to permit passage of said liquid through the filter 23, but to prevent the passage of the particulate material 20 through the filter 23. The filter 23 defines a filter direction x, and thus permits the liquid to pass through the filter 23 in the filter direction x. The cartridge 9 also includes a second filter 24 arranged at the inlet 21 to permit passage of the liquid through the filter 24, but to prevent passage of the particulate material 20 through the filter 24. Also the second filter 24 defines a filter direction x and permits the liquid to pass through the filter 24 in the filter direction x. It is to be noted that according to this invention such a filter 23 is provided at the outlet 22. The provision of the second filter 24 at the inlet 21 is preferable, but not mandatory.

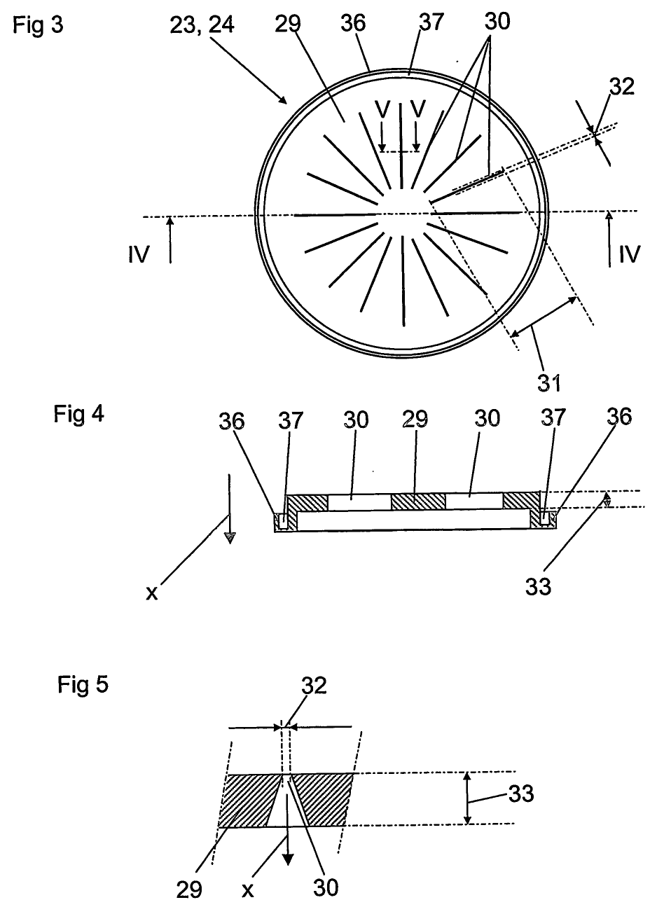

The filters 23 and 24 disclosed in FIG. 3 rest on a respective support member in the form of a shoulder 25, 26 extending around the inner periphery of the inner space 10 in the proximity of the inlet 21 and the outlet 22, respectively. Furthermore, a respective smaller shoulder 27 and 28 extends around the inner periphery of the inner space 10 above the filter 24 and 23, respectively, in order to permit the locking of the filters 23, 24 at their respective position on the shoulders 25, 26.

Preferably, the filters 23 and 24 are identical to each other. Two different embodiments of the filters 23, 24 are explained below with reference to FIGS. 3-7.

FIGS. 3-5 disclose a first embodiment of the filter 23, 24. The filter 23, 24 has a filter element with the shape of a substantially circular and substantially plane disc 29 having a main extension plane. It is to be noted, that the thickness of the disc 29 is exaggerated in the figures in order to simplify the explanation of the filter construction. The filter 23, 24 includes a number of slit-shaped openings 30. Each such opening 30 has a first extension, indicated by the line 31 in FIG. 3 for one of the openings 30. Each opening 30 also has a second extension, indicated by the line 32 in FIGS. 3 and 5. The second extension 32 is substantially perpendicular to the first extension 31. Both the second extension 32 and the first extension 31 are substantially perpendicular to the filter direction x.

In accordance with the present invention, the second extension 32 is significantly shorter than the first extension 31. Moreover, the second extension 32 is significantly shorter than the length 33 of the slit-shaped opening 30 in the filter direction x. For instance, the length 33 may be 10-100 times the second extension 32. In particular, the second extension 32 is equal to or less than 0.12 mm, preferably equal to or less than 0.10 mm or even 0.08 mm. Moreover, the second extension 32 is equal to or more than 0.02 mm, preferably equal to or more than 0.04 mm. According to a preferred embodiment, the second extension 32 is approximately 0.06 mm.

The slit-shaped openings 30, which extend through the disc 29, are, in the embodiment disclosed in FIGS. 3-5, provided to extend in a radial direction with regard to the first extension 31 and a centre point of the disc 29. However, the slit-shaped openings 30 may also be arranged to extend in other directions, for instance the disc 29 may include a plurality of slit-shaped openings 30 extending in parallel to each other. The disc 29 is made in a polymer material, for instance polycarbonate or polypropylene. The disc 29 may be manufactured through an injection moulding process by injecting said polymer material into a mould cavity having the shape of the disc 29. Each slit-shaped opening 30 has a first end and a second end. In FIG. 5 the first end is an upstream end and the second end a downstream end with respect to the filter direction x. As appears from FIG. 5, the second extension 32 of the slit-shaped opening 32 increases in the filter direction x from a minimum value at the upstream end of the slit-shaped opening 30 to a maximum value at the downstream end of the slit-shaped opening 30. Such a shape of the slit-shaped opening facilitates the injection moulding of the disc 29. It is to be noted here that the slit-shaped openings 30 of the filter 23, 24 may also be arranged in an opposite manner with respect to the filter direction x, depending on the particular circumstances. For instance it could in same cases be advantageous if the thinnest end of the slit-shaped openings 30 faces the particulate material although this is not necessary for a proper functioning of the filter 23, 24.

The filter 23, 24 includes a circumferential flexible edge portion 36 formed as a part of the disc 29. The edge portion 36 is flexible in an radial inward direction and formed by the provision of a circumferential groove 37 extending radially inside the edge portion 36. Consequently, the flexible edge portion 36 may be bent radially inwardly when the filter 23, 24 is introduced at its position on the shoulder 25, 26 in order to pass the shoulder 27, 28. After having passed the shoulder 27, 28, the flexible edge portion 36 may flex back to the outer position disclosed in FIG. 4.

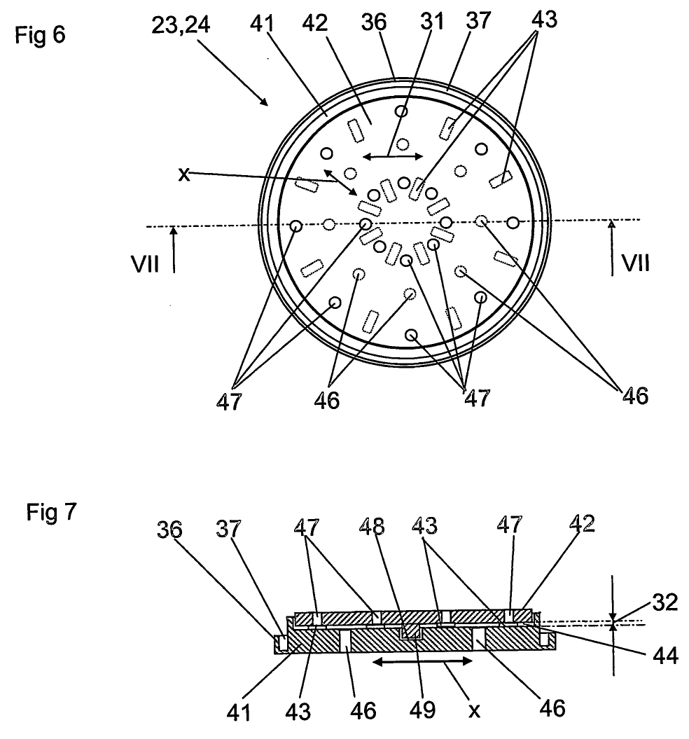

FIGS. 6 and 7 discloses a second embodiment of the filter 23, 24. The filter 23, 24 according to this embodiment includes a filter element having two discs, a first disc 41 and a second disc 42. The discs 41 and 42 are both substantially circular and substantially plane and have a respective main extension plane. The discs 41, 42 are arranged substantially in parallel with each other and separated from each other by means of a number of distance members 43. The distance members 43 form a part of and extend from one of the discs 41, 42. In the embodiment disclosed, the distance members are formed on the second disc 42. Thanks to the distance members 43, an interspace 44 is formed between the discs 41 and 42. The distance members 43 have a predetermined height defining the thickness of the interspace 44.

In the second embodiment, the filter direction x extends, in contrast to the first embodiment, in parallel with the discs 41 and 42. The slit-shaped opening 30 is formed by the interspace 44. Consequently, the second extension 32 correspond to the height of each distance member 43.

The first disc 41 includes a number of apertures 46 extending through the first disc 41 and forming outlet passages from the interspace 44. The second disc 44 also includes a number of apertures 47 forming an inlet passage to the interspace 44. The apertures 46 of the first disc 41 are arranged in such a way that they are not positioned opposite any one of the apertures 47 of the second disc 42. More precisely, the apertures 47 are arranged along a radially inner ring and a radially outer ring whereas the apertures 46 are arranged along a ring in an intermediate position between said inner ring and said outer ring. It is to be noted, that the apertures 46, 47 also may be arranged in other positions than the ones disclosed.

The liquid passing through the filter 23, 24 will thus enter the interspace 44 via one of the apertures 47 and flow through the interspace 44 in the filter direction x to one of the apertures 46 of the first disc 41 to be discharged from the filter 23, 24. Since the liquid may flow from an aperture at said outer ring or from an aperture along said inner ring towards an aperture along said intermediate ring, the flow direction in the second embodiment includes all directions in a plane being parallel with the main extension planes of the discs 41, 42. This is indicated by the double arrow x in FIG. 7.

The distance members 43 are positioned between the apertures 47 along said inner ring and between the apertures 47 along the said outer ring. More precisely, a distance member 43 is provided between each pair of adjoining apertures along said inner and outer rings.

The first disc 41 also includes a central cavity 48 arranged to receive a central projection 49 of the second disc 42. By means of the cavity 48 and the projection 49 the second disc 42 may be securely positioned in the first disc 41.

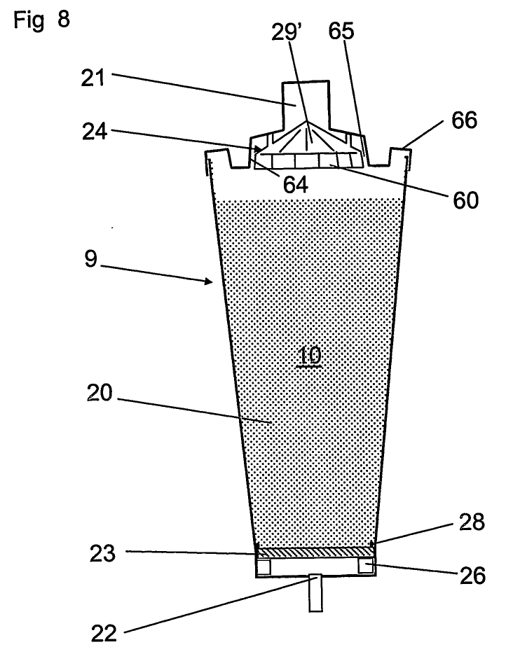

FIG. 8 discloses the cartridge 9 with a second filter 24 according to a third embodiment. The second filter 24 is arranged at the inlet 21 to permit passage of the liquid through the second filter 24, but to prevent passage of the particulate material 20 through the second filter 24. It is pointed out that the size of the filter 24 in relation to cartridge may be different than disclosed in FIG. 8. Advantageously, the second filter 24 is significantly smaller in relation to the cartridge 9 than disclosed in FIG. 8.

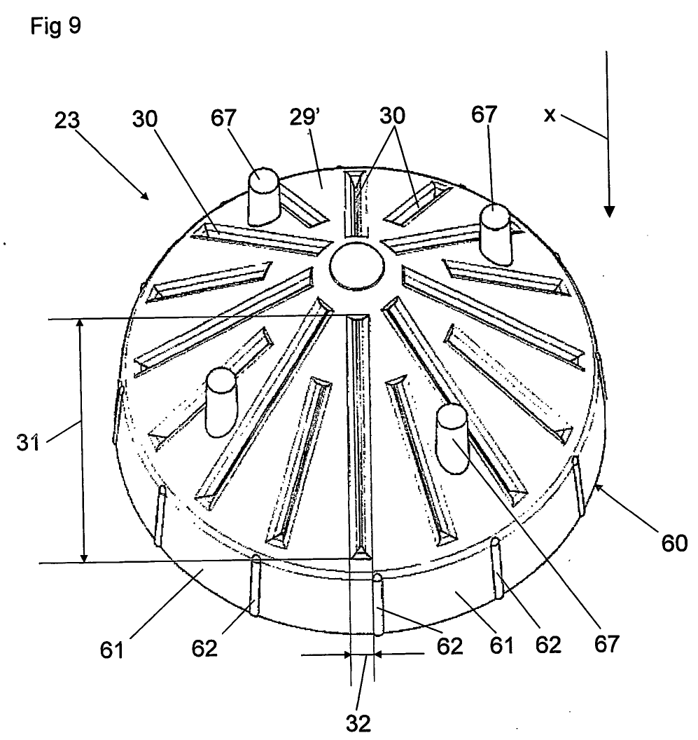

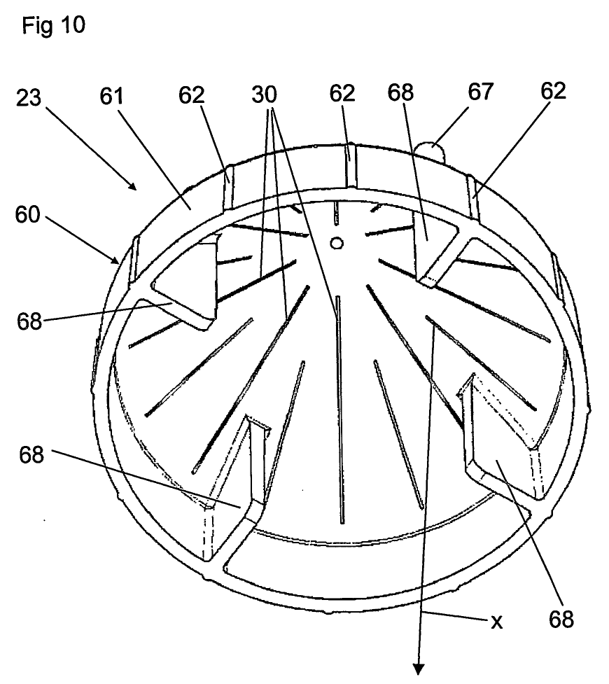

Also in this case the second filter 24 defines a filter direction x and permits the liquid to pass through the filter 24 in the filter direction x. The second filter 24 according to the third embodiment is disclosed more closely in FIGS. 9 and 10. The second filter 24 includes a filter element 29′ that has a conical shape. The filter element 29′ is relatively thin and has a thickness of material corresponding to the thickness of material of the disc 29 shown in the first embodiment. The filter element 29′ thus has a conical inner surface facing the inner space of the cartridge 9 and an opposite conical outer surface. A plurality of slit-shaped openings 30 extend through the filter element 29′. The first extension 31 of each slit-shaped opening 30 extends in a radial direction towards a centre point of the filter element 29′, whereas the second extension 32 extends in a tangential direction. The dimensions of the first extension 31 and the second extension 32 are substantially the same as in the first embodiment. Since the thickness of material is substantially the same as in the first embodiment the length 33, see FIG. 5 is substantially the same as in the first embodiment.

The second filter 24 according to the third embodiment also includes a peripheral support portion 60 connected to a lower end portion of the filter element 29′. The peripheral support portion 60 has a peripheral surface 61 and includes a plurality of longitudinal ridges 62 projecting from the peripheral surface 61 and extending in a longitudinal direction, nearly in parallel to each other. The peripheral surface 61 is nearly cylindrical or slightly conical so that the peripheral surface is somewhat tapering, with a small cone angle, towards the filter element 29′. The peripheral support portion 60 abuts an inner wall 64 of the cartridge 9. More precisely, the longitudinal ridges 62 abut the inner wall 64 of the cartridge 9 in such a way that a thin gap 65 is formed between the peripheral surface 61 and the inner wall 64. The gap 65, which is divided into a plurality of gap portions by the ridges 62, provides a further passage for the liquid. The height of the ridges 62 is selected in such a way that the width of the gap 65 is substantially the same as the length of the second extension 32. In the embodiment disclosed in FIG. 8, the inner wall 64 is formed by a cover 66, which is attachable to an upper end of the cartridge 9 for closing the cartridge 9 when it has been filled with the particulate material. The inner wall 64 has substantially the same cone angel as the peripheral surface 61. The second filter 24 of the third embodiment is attached to the cover 66 by being pressed against the inner wall 64. The second filter 24 of the third embodiment also includes a number of support posts 67, in the embodiment disclosed four posts 67, which are abutting an upper wall adjoining the slightly conical inner wall 64 for defining the position of the filter with respect to the cartridge 9, or more precisely the cover 66. Furthermore, the second filter 24 of the third embodiment includes a number of supporting wings, in the embodiment disclosed four wings 68, which are arranged on an inner peripheral surface being opposite to the peripheral surface 61 of the peripheral support 60, and on the conical inner surface of the filter element 29′. The wings 68 extend in a radial direction. The cover 66 and the second filter 24 according to the third embodiment are designed in such a manner that assemblies of the cover 66 and the second filter 24 may be stacked onto each other during manufacturing and transport. Thereby the pipe-shaped inlet 21 of the cover is dimensioned to extend into the second filter of an adjacent assembly so that the height of the package of assemblies is minimised.

The slit-shaped openings 30 of the filter element 29′ of the second filter 24 according to the third embodiment also has a first end and a second end. In the embodiment disclosed the first end is an upstream end and the second end a downstream end with respect to the filter direction x. Moreover, in the embodiment disclosed, the second extension 32 of the slit-shaped opening 30 decreases in the filter direction x from a maximum value at the first, upstream end of the slit-shaped opening 30 to a minimum value at the second, downstream end of the opening 30. Also the second filter 23 and its filter element 29′ according to the third embodiment is made through an injection moulding process.

It is to be noted that the filter according to the third embodiment disclosed in FIGS. 9 and 10 may also be used as the first filter at the outlet 22 of the cartridge 9. In this case the filter element 29′ may be arranged with the tip of the cone pointing away from the cartridge, i.e. the filter is turned 180° with respect to the filter direction x. Also when provided at the outlet 22, the height of the ridges 62 is selected in such a way that the width of the gap is substantially the same as the length of the second extension 32. It is also possible, in principle, to arrange one or both of the filters 23, 24 with the cone pointing inwardly towards the particulate material.

It is also to be noted that the cartridge may be used in any direction so that the outlet 22 becomes the inlet 21 and the inlet 21 becomes the outlet 22.

The present invention is not limited to the embodiments disclosed but may be varied and modified within the scope of the following claims. In the embodiment disclosed in FIGS. 3-5 and 8-10, the first extension 31 is substantially straight. It is to be noted, however, that the first extension 31 as an alternative may be curved.

1. A filter for a cartridge containing a particulate material, wherein the filter is intended to permit passage of a liquid through the filter and thus the cartridge, but to prevent passage of the particulate material, wherein the filter permits the liquid to pass through the filter in a filter direction (x), wherein the filter includes at least on slit-shaped opening being substantially perpendicular to the filter direction (x) and to the first extension, wherein the second extension is significantly shorter than the first extension.

2. A filter according to claim 1, wherein the second extension is significantly shorter than the length of the slit-shaped opening in the filter direction (x).

3. A filter according to one of claims 1 or 2, wherein the second extension is equal to or less than 0.12 mm.

4. A filter according to one of claims 1 or 2, wherein the second extension is equal to or less than 0.10 mm or 0.08 mm.

5. A filter according to claim 1, wherein the second extension is equal to or more than 0.02 mm.

6. A filter according to claim 1, wherein the second extension is equal to or more than 0.04 mm.

7. A filter according to claim 1, wherein the second extension is approximately 0.06 mm.

8. A filter according to claim 1, wherein the filter is made of a polymer material, including one of polypropylene and polycarbonate.

9. A filter according to claim 1, wherein the first extension is substantially perpendicular to the filter direction (x).

10. A filter according to claim 1, wherein the filter includes a filter element, wherein the slit-shaped opening extends through the filter element.

11. A filter according to claim 10, wherein the filter includes a plurality of slit-shaped openings, which extend through the filter element.

12. A filter according to claim 11, wherein the first extension of each slit-shaped opening extends in a radial direction towards a centre point of the filter element.

13. A filter according to any one of claims 10 to 12, wherein the filter element has a shape of a substantially plane disc.

14. A filter according to any one of claims 10 to 12, wherein the filter element has a conical shape.

15. A filter according to claim 14, wherein the filter includes a peripheral support portion connected to the filter element and adapted to abut an inner wall of the cartridge.

16. A filter according to claim 15, wherein the peripheral support portion has a peripheral surface and includes a plurality of ridges projecting from the peripheral surface and adapted to abut the inner wall of the cartridge so that a thin gap is formed between the peripheral surface and the inner wall, said gap providing a further passage for the liquid.

17. A filter according to one of claims 10 to 12, wherein the slit-shaped opening of the filter element has a first end and a second end, wherein the second extension of the slit-shaped opening increases from a minimum value at the one of the ends of the slit-shaped opening to a maximum value at the other end of the opening.

18. A filter according to one of claims 1, 2, or 5 to 9 wherein the filter includes a filter element formed by a first disc and a second disc, which are arranged substantially in parallel with each other and separated from each other by an interspace that form the slit-shaped opening.

19. A filter according to claim 18, wherein the interspace is formed by distance members arranged in the interspace between the discs, each of said distance members having a predetermined height corresponding to the second extension.

20. A filter according to claim 19, wherein each of said distance members includes a projection extending from one of the first disc and the second disc.

21. A filter according to claim 18, wherein the first disc is provided with at least one aperture forming an outlet passage to the interspace, and that the second disc is provided with at least one aperture forming an inlet passage from the interspace.

22. A filter according to claim 1, wherein the filter is made through an injection moulding process.

23. A cartridge containing a particulate material wherein the cartridge includes:
an inner space for housing the particulate material;
an inlet arranged to permit the introduction of a liquid into the inner space;
an outlet arranged to permit the discharge of liquid from the inner space; and
at least a first filter arranged at the outlet and to permit passage of the liquid through the filter, but to prevent passage of the particulate material through the filter, wherein the filter permits the liquid to pass through the filter in a filter direction (x), wherein the filter includes at least one slit-shaped opening, which has a first extension and a second extension being substantially perpendicular to the filter direction (x) and to the first extension, wherein the second extension is significantly shorter than the first extension.

24. A cartridge according to claim 23, wherein the cartridge includes a second filter arranged at the inlet and to permit passage of the liquid through the filter, but to prevent passage of the particulate material through the filter, wherein the second filter permits the liquid to pass through the filter in a filter direction (x), wherein the second filter includes at least one slit-shaped opening, which has a first extension and a second extension being substantially perpendicular to the filter direction (x) and to the first extension, wherein the second extension is significantly shorter than the first extension.

25. A cartridge according to claim 23 or 24, wherein the second extension is significantly shorter than the length of the slit-shaped opening in the filter direction (x).

26. A cartridge according to claim 23 or 24, wherein the second extension is equal to or less than 0.12 mm.

27. A cartridge according to claim 23 or 24, wherein the second extension is equal to or less then 0.10 mm or 0.08 mm.

28. A cartridge according to claim 23 or 24, wherein the second extension is equal to or more than 0.02 mm.

29. A cartridge according to claim 23 or 24, wherein the second extension is equal to or more than 0.04 mm.

30. A cartridge according to claim 23 or 24, wherein the second extension is approximately 0.06 mm.

31. A cartridge according to claim 23 or 24 wherein the filter is made of a polymer material, including one of polypropylene and polycarbonate.

32. A cartridge according to claim 23 or 24, wherein the first extension is substantially perpendicular to the filter direction (x).

33. A cartridge according to claim 23 or 24, wherein the filter includes a filter element wherein the slit-shaped opening extends through the filter element.

34. A cartridge according to claim 33, wherein the filter includes a plurality of slit-shaped openings which extend through the filter element.

35. A cartridge according to claim 34, wherein the first extension towards a centre point of the filter element.

36. A cartridge according to claim 33, wherein the filter element has a shape of a substantially plane disc.

37. A cartridge according to claim 23 or 24, wherein the filter element of the second filter has a conical shape.

38. A cartridge according to claim 33, wherein the slit-shaped opening of the filter element has a first end and a second end, wherein the second extension of the slit-shaped opening increases from a minimum value atone of the ends of the slit-shaped opening to a maximum value at the other end of the opening.

39. A cartridge according to claim 23 or 24, wherein the filter includes a filter element formed by a first disc and a second disc, which are arranged in parallel with each other and separated from each other by an interspace that form the slit-shaped opening.

40. A cartridge according to claim 39, wherein the interspace is formed by distance members arranged in the interspace between the discs, each of said distance members having a predetermined height corresponding to the second extension.

41. A cartridge according to claim 40, wherein each of said distance members includes a projection extending from one of the first disc and the second disc.

42. A cartridge according to claim 39, wherein the first disc is provided with at least one aperture forming an outlet passage to the interspace, and that the second disc is provided with at least one aperture forming an inlet passage from the interspace.

43. A cartridge according to claim 23 or 24, wherein the filter is made through an injection moulding process.

44. A cartridge arranged to contain a particulate material, wherein the cartridge includes:
an inner space for housing the particulate material;
an inlet arranged to permit the introduction of a liquid into the inner space;
an outlet arranged to permit the discharge of liquid from the inner space; and
at least a second filter arranged at the inlet and to permit passage of the liquid through the filter, but to prevent passage of the particulate material through the filter, wherein to second filter permits the liquid to pass through the filter in a filter direction (x), wherein the second filter includes at least one slit-shaped opening, which has a first extension and a second extension being substantially perpendicular to the filter direction (x), and to the first extension, wherein the second extension is significantly shorter than the first extension.

45. A cartridge according to claim 44, wherein the second extension is significantly shorter than the length of the slit-shaped opening in the filter direction (x).

46. A cartridge according to one of claims 44 or 45, wherein the second extension (is equal to or less than 0.12 mm.

47. A cartridge according to one of claims 44 or 45, wherein the second extension is equal to or less than 0.10 mm or 0.08 mm.

48. A cartridge according to one of claims 44 or 45, wherein the second extension is equal to or more than 0.02 mm.

49. A cartridge according to one of claims 44 or 45, wherein the second extension is equal to or more than 0.04 mm.

50. A cartridge according to an one of claims 44 or 45, wherein the second extension is approximately 0.06 mm.

51. A cartridge according to one of claims 44 or 45, wherein the filter is made of a polymer material, including one of polypropylene and polycarbonate.

52. A cartridge according to one of claims 44 or 45, wherein the first extension 3 is substantially perpendicular to the filter direction (x).

53. A cartridge according to one of claims 44 or 45, wherein the filter includes a filter element, wherein the slit-shaped opening extends through the filter element.

54. A cartridge according to claim 53, wherein the filter includes a plurality of slit-shaped openings, which extend through the filter element.

55. A cartridge according to claim 54, wherein the first extension of each slit-shaped opening extends in a radial direction towards a centre point of the filter element.

56. A cartridge according to claim 53, wherein the filter element has a conical shape.

57. A cartridge according to claim 53, wherein the filter includes a peripheral support portion connected to the filter element and abutting an inner wall of the cartridge.

58. A cartridge according to claim 57, wherein the peripheral support portion has a peripheral surface and includes a plurality of ridges projecting from the peripheral surface and abutting the inner wall of the cartridge, wherein a thin gap is formed between the peripheral surface and the inner wall, said gap providing a further passage for the liquid.

59. A cartridge according to claim 44 or 45, wherein the slit-shaped opening of the filter element has a first end and a second end wherein the second extension of the slit-shaped opening decreases from a maximum value at the first end of the slit-shaped opening to a minimum value at the second end of the opening.

60. A cartridge according to claim 44, wherein the filter is made through an injection moulding process.

61. A use of a filter in a cartridge containing a particulate material, wherein the cartridge includes:
an inner space for housing the particulate material;
an inlet arranged to permit the introduction of a liquid into the inner space an outlet arranged to permit discharge of liquid from the inner space; and
at least one filter arranged at the outlet and to permit passage of the liquid through the filter, but to prevent passage of the particulate material through the filter, wherein the filter permits the liquid to pass through the filter in a filter direction (x), wherein the filter includes at least one slit-shaped opening, which has a first extension, the use including the step of supplying said liquid to the cartridge in such a way that the liquid passes through the particulate material and thereby dissolves at least a part of the particulate material to form a liquid solution.

62. A use according to claim 61, wherein the liquid is a dialysis liquid.

63. A use according to claim 61 or 62, wherein the particulate material includes bicarbonate and/or sodium chloride.

64. A use according to claim 61, wherein the liquid includes a cleaning substance.

65. A system for preparing a liquid solution for a medical procedure, the system including:
a cartridge containing a particulate material in an inner space thereof and including an inlet and an outlet;
a first liquid conduit having a first end communicating with a source of liquid to withdraw the liquid into the first liquid conduit and a second end;
a second liquid conduit having a first end communicating with a source of liquid and a second end communicating with the inlet of the cartridge for introducing the liquid into the inner space to produce a concentrate liquid solution containing at least a part of the particulate material dissolved in the liquid;
a third liquid conduit communicating with the outlet of the cartridge and with a mixing point in the first liquid conduit intermediate said first and second ends for conducting said concentrate liquid solution from the cartridge into said first liquid conduit to be mixed with the liquid being conducted through the first liquid conduit to thereby produce said liquid solution in the first liquid conduit for delivery to said second end of the first liquid conduit; and
at least one filter g arranged at the outlet and to permit passage of the liquid through the filter, but to prevent passage of the particulate material through the filter, wherein the filter permits the liquid to pass through the filter in a filter direction (x), wherein the filter includes at least one slit-shaped opening, which has a first extension and a second extension being substantially perpendicular to the filter direction (x) and to the first extension, wherein the second extension is significantly shorter than the first extension.

66. A system according to claim 65, wherein the cartridge includes a second filter arranged at the inlet and to permit passage of the liquid through the filter, but to prevent passage of the particulate through the filter, wherein the second filter permits the liquid to pass through the filter in a filter direction (x), wherein the second filter includes at least one slit-shaped opening, which has a first extension and a second extension being substantially perpendicular to the filter direction (x) and to the first extension, wherein the second extension is significantly shorter than the first extension.

67. A system according to claim 65 or 66, wherein the filter is intended to permit passage of a liquid through the filter and thus the cartridge, but to prevent passage of the particulate material, wherein the filter permits the liquid to pass through the filter in a filter direction (x), the filter includes at least on slit-shaped opening being substantially perpendicular to the filter direction (x) and to the first extension, wherein the second extension is significantly shorter than the first extension, said second extension being significantly shorter than the length of the slit-shaped opening in the filter direction (x).

68. A system according to claim 65, wherein the liquid is a dialysis liquid.

69. A system according to claim 65, wherein the particulate material includes bicarbonate and/or sodium chloride.
